(19) United States
(12) Patent Application Publication
(10) Pub. No.: US 2009/0276774 A1
(43) Pub. Date: Nov. 5, 2009

(54) Access control for virtual machines in an information system

(76) Inventor: Junji Kinoshita, Sunnyvale, CA (US)

Correspondence Address: MATTINGLY & MALUR, P.C., 1800 DIAGONAL ROAD, SUITE 370, ALEXANDRIA, VA, 22314, US

(21) Appl. No.: 12/149,428

(22) Filed: May 1, 2008

(51) Int. Cl. G06F 9/455

(52) U.S. Cl. 718/1

(57) ABSTRACT

An information system includes host computers having virtual machine programs running thereon for generating virtual machines. A storage system in communication with the host computers stores an image file corresponding to each virtual machine running on the host computers. In some embodiments, when the storage system receives an access request to a particular image file corresponding to a particular one of the virtual machines running on one of the host computers, the storage system determines whether the access request is authorized based upon an identifier of the particular virtual machine and a location of the particular virtual machine. In some embodiments, the storage system sends an inquiry to a management computer when determining whether the access request is authorized and, based upon the location of the particular virtual machine and the identifier of the particular virtual machine, the management computer sends a reply as to whether the access request is authorized.

### BACKGROUND OF THE INVENTION

The present invention relates generally to information systems. Energy consumed by data centers and other information technology (IT) systems is becoming an ever increasing portion of overall energy consumption worldwide. Many companies or organizations now have concerns about the energy consumption of their IT systems, and are looking for ways to decrease power usage. In general, there are various kinds of solutions for reducing energy consumption of IT systems. Virtualization technology is considered to be one promising solution. Using virtualization technology, IT system administrators can consolidate multiple servers into one physical server by running multiple virtual machines on the one physical server. As an added advantage, virtual machines can be dynamically moved from one physical server to another physical server to achieve load balancing, increased availability, and so forth. As a result of such virtualization technology, IT system administrators are able to increase the overall utilization of servers in their IT systems and decrease energy consumption.

On the other hand, it can be difficult for other devices in the information system to observe the activities of virtual machines as compared with conventional servers, especially devices outside of the servers themselves. For example, when virtual machines running on a server are utilizing a storage system, depending on the configuration of the particular IT system, the storage system may not be able to recognize individual virtual machines running on the server. Furthermore, the storage system has no way of knowing a particular location of a virtual machine or tracking the migration of a particular virtual machine to another physical server. Accordingly, the storage system cannot appropriately restrict access from each virtual machine to particular files or volumes within the storage system for implementing access control, such as when first booting up a virtual machine. For example, many information systems usually deploy access control mechanisms into data paths between servers and such files or volumes to prevent unauthorized access to the information stored therein, but there is no way to accomplish this function when virtual machines are implemented in the servers.

Related art includes US Pat. App. Pub. No. 2004/0049588 to Shinohara et al., entitled “Access Management Server, Method Thereof, and Program Recording Medium”, and US Pat. App. Pub. No. 2006/0080542 to Takeuchi et al., entitled “Access Control System, Authentication Server, Application Server, and Packet Transmission Device”, the entire disclosures of which are incorporated herein by reference. Further, N-Port virtualization is discussed, for example, in the white paper “Virtual Server-SAN connectivity—the emergence of N-Port ID Virtualization”, Emulex Corp., Costa Mesa, Calif., April 2007, the disclosure of which is also incorporated herein by reference.

### BRIEF SUMMARY OF THE INVENTION

Exemplary embodiments of the invention are used for information systems, such as those implementing server virtualization, virtual machines, and host computers connected to storage systems via networks, or the like. Exemplary embodiments of the invention control and manage access from virtual machines to data within storage systems, for example, even when the virtual machines have been migrated to other physical servers. These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a hardware and software configuration in which the method and apparatus of the invention may be applied.

FIG. 2 illustrates an exemplary data structure of a virtual machine management table.

FIG. 3 illustrates an exemplary data structure of an access control configuration table.

FIG. 4 illustrates an exemplary process for transfer of the virtual machine.

FIG. 5 illustrates an exemplary process for carrying out access control.

FIG. 6 illustrates an example of a hardware and software configuration in which the method and apparatus of second embodiments of the invention may be applied.

FIG. 7 illustrates an exemplary data structure of an access control rule table.

FIG. 8 illustrates an exemplary process to transfer a virtual machine.

FIG. 9 illustrates an exemplary process for carrying out access control.

FIG. 10 illustrates an example of a hardware and software configuration in which the method and apparatus of third embodiments of the invention may be applied.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment” or “this embodiment” means that a particular feature, structure, or characteristic described in connection with the embodiment is included in at least one embodiment of the invention, and the appearances of these phrases in various places in the specification are not necessarily all referring to the same embodiment. Additionally, the drawings, the foregoing discussion, and following description are exemplary and explanatory only, and are not intended to limit the scope of the invention in any manner. For example, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations on data bits within a computer. These algorithmic descriptions and representations are the means used by those skilled in the data processing arts to most effectively convey the substance of their work to others skilled in the art. An algorithm is here, and generally, understood to be a series of defined steps leading to a desired end state or result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing”, “computing”, “calculating”, “determining”, “displaying”, or the like, can include the action and processes of a computer system or other information processing device that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer readable storage medium, such as, but not limited to optical disks, magnetic disks, read-only memories (ROMs), random access memories (RAMs), solid state devices and drives, or any other type of media suitable for storing electronic information. The algorithms and displays presented herein are not inherently related to any particular computer or other apparatus. Various general-purpose systems may be used with programs in accordance with the teachings herein, or it may prove convenient to construct a more specialized apparatus to perform desired method steps. The structure for a variety of these systems will appear from the description set forth below. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Embodiments of the invention, as will be described in greater detail below, provide systems, methods and computer programs for enforcing and managing access control in a virtualized environment. The exemplary access control techniques for virtual machines may include a virtual machine management computer that manages the location and movement of virtual machines running on servers. In exemplary embodiments, a storage system communicates with the virtual machine management computer and asks the virtual machine management computer to validate an attempted access from a virtual machine to data in the storage system. In exemplary embodiments, the storage system can also receive access control rule information from the virtual machine management computer to validate an access autonomously.

### FIRST EMBODIMENTS

### Hardware & Software Architecture

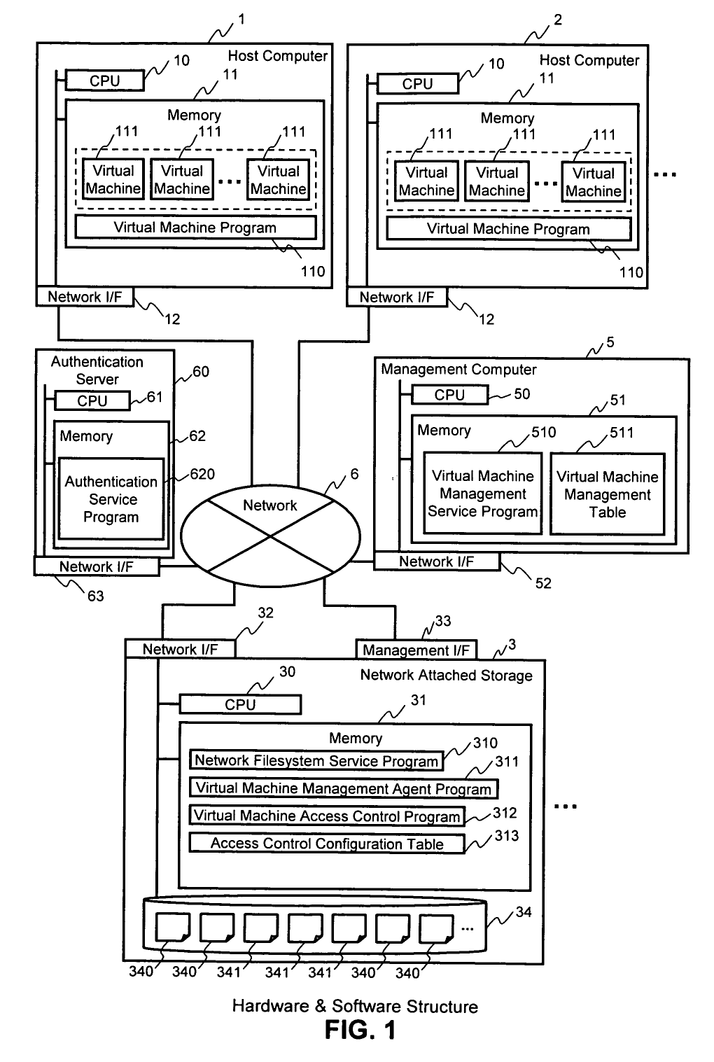

FIG. 1 illustrates an example of physical hardware and logical software architecture in which the first exemplary embodiments of the invention may be carried out. The overall system consists of at least two host computers (e.g., servers), such as a first host computer 1 and a second host computer 2, and at least one network attached storage 3. Also included may be a management computer 5, and an authentication server 60. The host computers 1, 2, the network attached storage 3, the management computer 5 and the authentication server 60 may be connected to each other for communication through a network 6. Network 6 may be an Ethernet® network such as for a forming a local area network (LAN), or other known network type enabling communication between the attached devices.

Each host computer 1, 2 is comprised of at least one CPU 10, at least one memory 11 and at least one network interface 12 that is used for connecting to network 6 and communicating therewith. Virtual machines and other software programs are able to run on host computers 1, 2. These programs and other information used by these programs may be stored in memory 11 or other computer readable medium, and CPU 10 executes these programs. Memory 11 may be any combination of solid state memory devices and/or hard disk drives, mass storage devices, or the like.

A virtual machine monitor program 110 provides a virtualization platform that enables generation and monitoring of multiple virtual machines running on a host computer at the same time. Examples of suitable virtual machine monitor programs that create and monitor virtual machines include those available from VMware Inc., of Palo Alto, Calif. Further included as part of the virtual machine monitor program 110, or as a separate program, may be a capability such as is provided by VMware's Vmotion™, which enables running virtual machines to be moved from one physical server to another with no impact to end users. For example, an operating system (OS) and one or more applications might be run on each virtual machine. Movement of a particular virtual machine also results in movement of the OS and application(s) running thereon, and thus results in relocation of the associated processing loads for running the particular OS and application(s).

Virtual machines 111 may be, in some aspects, a software partition of a portion of the resources of a host computer in which the partitioned computer resources are caused to act as an individual computer. Thus, a number of instances of virtual machines 111 may be created on a single host computer 1, 2. In the present embodiments, the storage resources used by each of virtual machines 111 are stored in network attached storage 3 as an image file 340 by virtual machine monitor program 110, along with various other types of files 341. An image file contains the boot information for a virtual machine 111, such as the OS image used to boot up the particular virtual machine. For example, an image file might include a configuration file, which stores settings of the virtual machine and an NVRAM or boot file that stores the state of the virtual machine's BIOS (Basic Input/Output System), which is accessed to boot the virtual machine and load the OS. Also included in the image file may be a virtual disk file, which stores the contents of the virtual machine's hard disk drive, such as the OS that runs on the virtual machine and any applications that run on the virtual machine.

Consequently, the image files 340 are different from other files 341, such as any kind of data files other than virtual machines' system data. Image files 340 are accessed by virtual machine monitor program 110 when the virtual machines 111 boot up and while the virtual machines 111 are running, whereas the other files 341, such as data files, might be accessed by any kind of entities including particular applications running on virtual machines 111 and virtual machines 111 only after the particular virtual machine has completed boot up. For example, in the case of a network attached storage system 3, virtual machine monitor program 110 reads/writes data from/to a virtual machine's image file 341 using network filesystem protocol, such as Network File System (NFS) and Common Internet File System (CIFS), and so forth, when the virtual machine boots up and while the virtual machine is running, because the image file 340 containing the virtual machine's operating system data is stored and managed by network filesystem client capability of virtual machine monitor program 110. However, this arrangement can cause a security problem with respect to accesses to image files 340 despite the fact that there are typically several security mechanisms in place. For example, when network attached storage 3 receives accesses to image files 340 from virtual machine monitor program 110, network filesystem service program 310 is able to check for a network identifier, such as an IP address of the host computers that virtual machine monitor program 110 is supposed to be running on. Checking for a network identifier is not a strong security mechanism since a network identifier is able to be spoofed, but this is an easy security mechanism to carry out, and one that is commonly used. Network attached storage 3 also can use a better security mechanism based on authentication and authorization. For example, network filesystem service program 310 is able to authenticate virtual machine monitor program 110 and authorize accesses to image files 340 using the authentication mechanisms of the network filesystem protocols, such as NFS, CIFS and so forth. When network filesystem service program 310 authenticates and authorizes virtual machine monitor program 110, it validates authentication information such as user ID and password. Network filesystem service program 310 can also ask authentication server 60 to authenticate virtual machine monitor program 110 instead of performing authentication and authorization by itself. However, network filesystem service program 310 has no way to validate accesses from virtual machines to image files 340 because network attached storage 3 and network filesystem service program 310 cannot even identify virtual machines in terms of accesses to image files 340. Furthermore, network attached storage 3 and network filesystem service program 310 have no way of even recognizing the existence and location of virtual machines.

As described above, virtual machines can be moved between host computers, and thus, network attached storage 3 is not able to recognize which virtual machines are actually running on the virtual machine monitor program 110. Furthermore, network attached storage 3 and network filesystem service program 310 may not even be able to recognize that the virtual machine monitor program 110 is creating virtual environments on the host computers. Because network attached storage 3 and network filesystem service program 310 are only able to identify a network identifier and a network filesystem client, they typically are not able to distinguish between a virtual machine monitor program with network filesystem client capability, other application programs with network filesystem client capability, or generic network filesystem client programs. If a malicious user or program is able to take advantage of one of host computers or virtual machine monitor programs 110, network attached storage system cannot appropriately limit accesses to image files 340 using the existing security mechanisms. Under existing security mechanisms, all host computers and virtual machine monitor programs that might have virtual machines running on them are provided with rights to access to any image files. As a result, a malicious user or program may be able to inject a malicious code into any image files. In terms of other files 341, however, network attached storage 3 is able to appropriately control access to the other files 341, using conventional means, such as IP address control.

Typically, virtual machine monitor program 110 enables a virtual machine 111 running a particular application to be transferred (i.e., migrated) from one host computer to another host computer for a number of different reasons (e.g., load balancing, increasing availability, and so forth). In the present embodiments, when it is desired to migrate a particular virtual machine to another computer, a virtual machine management service program 510 on management computer 5 sends a migration request to virtual machine monitor program 110 to transfer the particular virtual machine 111.

Network attached storage (NAS) systems, in general, are provided to enable storing of data via networks. There are various purposes for using a NAS system. In these embodiments, virtual machine monitor program 110 on host computer 1 and host computer 2 stores image files 340 of virtual machines 111 into a network attached storage 3. When multiple virtual machines 111 are running on the same host computer, network attached storage 3 cannot recognize which virtual machines 111 on the host computer are assessing which resources in the storage system 3. Network attached storage 3 includes at least one CPU 30, at least one memory 31, one or more mass storage devices 34, such as hard disk drives, solid-state drives, or the like, and at least one network interface 32 that is used for connecting to network 6. Network attached storage 3 also has at least one management interface 33 that allows administrators to manage and operate a network attached storage 3. Network attached storage 3 also contains one or more files 340, 341 stored on storage devices 34. Some of these files can be image files 340 of the virtual machines 111 running on host computers 1, 2. In addition a number of software programs may be running on network attached storage 3. These programs and information used by these programs may be stored in memory 31 or other computer readable medium, and CPU 30 executes these programs.

Network filesystem service program 310 provides an interface that allows host computers to store data in network attached storage 3. The interface can be conventional network file system mechanisms such as Network File System (NFS) and Common Internet File System (CIFS) protocols. When network filesystem service program 310 receives an access request from a host computer to the monitored image file 340, the network filesystem service program 310 invokes a virtual machine access control program 312. Before invoking virtual machine access control program 312, network filesystem service program 310 also can perform existing security mechanisms, such as a host computer network identification check (e.g., IP address authentication) or authentication of network filesystem client program, including virtual machine monitor program 110, having a capability of a network filesystem client program. The virtual machine access control program 312 provides access control capability to network attached storage 3. Virtual machine access control program 312 is invoked when network file system service program 310 receives an access request from a host computer to a monitored image file 340. Virtual machine access control program 312 then asks the virtual machine management service program 510 to validate the access request. Then, virtual machine access control program 312 determines whether to allow or deny the access request according to a response received from virtual machine management service program 510, and is also able to log the event.

Virtual machine management agent programs 311 provides an interface that allows an administrator to set access control configuration information to an access control configuration table 313 within the network attached storage 3 via the virtual machine management service program 510. Using the access control configuration information, an administrator is able to define image files 340 that should be monitored by network attached storage 3.

An access control configuration table 313 defines access control configuration information that is set by the administrator via the virtual machine management service program 510. Access control configuration table 313 is used by network filesystem service program 310 and a virtual machine access control program 312. Network filesystem service program 310 refers to the access control configuration table 313 to determine whether an access request from a host computer to a certain image file should be validated or not.

Management Computer 5 is comprised of at least one CPU 50, at least one memory 51, and at least one network interface 52 that is used for connecting to network 6. A number of software programs may be running on management computer 5. These programs and other information used by the programs are stored in memory 51 or other computer readable medium, and CPU 50 executes these programs.

Virtual machine management service program 510 provides an interface that allows an administrator to manage and operate virtual machines 111, virtual machine monitor programs 110, and virtual machine access control capability of network attached storage 3. For example, an administrator can move a virtual machine 111 from one host computer to another host computer via the virtual machine management service program 510. Virtual machine management service program 510 also can be configured to automatically move the virtual machine 111 when necessary, so as to achieve load balancing, high availability, and so forth.

When a virtual machine 111 is moved, virtual machine management service program 510 updates virtual machine management table 511 so that virtual machine management table 511 indicates correct location information of each virtual machine. An administrator also can set access control information to access control configuration table 313 within a network attached storage 3 via virtual machine management service program 510 and virtual machine management agent programs 311. Virtual machine management service program 510 also can validate an access request from a host computer to an image file 340 within the network attached storage 3 by checking the location of a virtual machine 111 using the virtual machine management table 511 in response to an access validation request from virtual machine access control program 312. Thus, when network attached storage 3 receives an access request from a host computer to a monitored image file 340, network attached storage 3 sends a corresponding inquiry to the virtual machine management service program 510 to determine whether the access request is authorized.

Virtual machine management table 511 defines location information of the virtual machines 111. When one of virtual machines 111 is transferred from one host computer to another host computer, virtual machine management table 511 is updated by the virtual machine management service program 510 so that the new location of the transferred virtual machine is registered in virtual machine management table. An administrator and virtual machine management service program 510 can recognize the location of each virtual machine 111 by referring to virtual machine management table 511.

Authentication Server 60 is comprised of at least one CPU 61, at least one memory 62, and at least one network interface 63 that is used for connecting to network 6. A number of software programs may be running on authentication server 6, and these may include an authentication service program 610. These programs and other information used by the programs are stored in memory 61 or other computer readable medium, and CPU 60 executes these programs for carrying out authentication and other services.

Authentication service program 610 can verify identification information of entities via networks. In these embodiments, network filesystem service program 310 can ask authentication server 60 to authenticate network filesystem client programs and virtual machine monitor programs 110 that have capabilities of network filesystem clients when they try to access to files stored on network attached storage 3. However, this cannot be applied to accesses from virtual machines 111 to image files 340 because the authentication server only can authenticate the virtual machine monitor programs 110 based on authentication information such as user ID and password for network filesystem protocol, and is not able to determine whether particular virtual machines are running on a particular host. Typically, authentication server 60 might be a Microsoft Domain Controller, a Kerberos authentication server, a RADIUS (Remote Authentication Dial In User Service) authentication server, or the like.

Data Structures

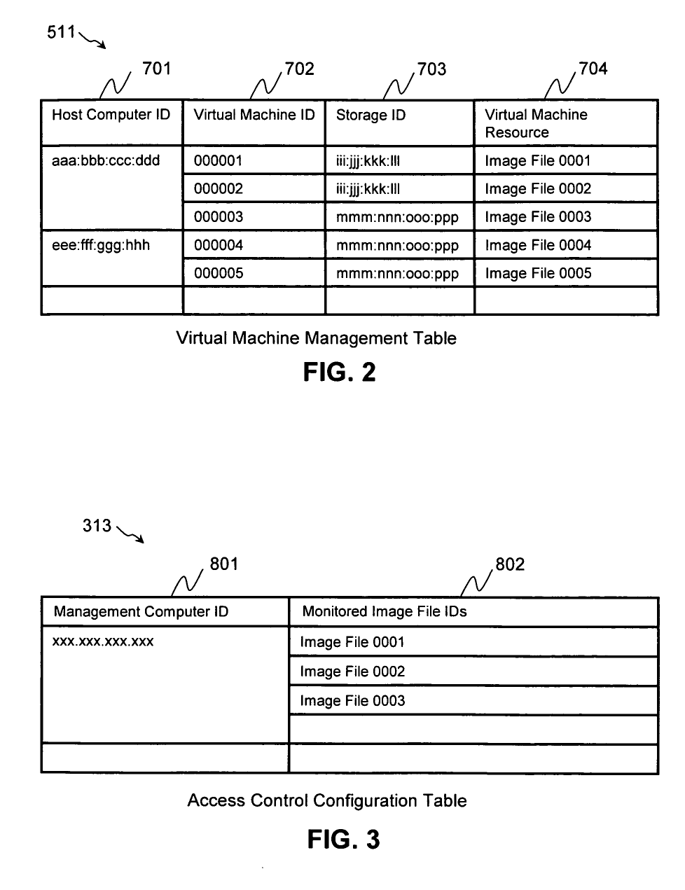

FIG. 2 illustrates an exemplary data structure of a virtual machine management table 511. Virtual machine management table 512 includes an entry for a host computer ID 701, which indicates a unique identifier applied to each host computer. In this embodiment, the IP address of each host computer may be used as the host computer identifier, although other identifiers alternatively may be used. A virtual machine ID 702 indicates unique identification information of each virtual machine 111. In this embodiment, a unique virtual machine ID is assigned to each virtual machine 111 by virtual machine management service program 510. A storage ID 703 indicates unique identification information of each network attached storage 3 in the information system. In this embodiment, the IP address of network interface 32 of network attached storage 3 may be used as the storage ID 703. A virtual machine resource entry 704 indicates identification information of each image file 340 of each virtual machine 111.

FIG. 3 illustrates an exemplary data structure of an access control configuration table 313. Access control configuration table 313 includes a management computer ID entry 801, which indicates unique identification information of management computer 5. In this embodiment, the IP address of management computer 5 is used as management computer ID 801. Monitored image file ID entry 802 indicates unique identification information of each image file 340 of virtual machines 111 that should be monitored by network attached storage 3. For example, the filename of the particular image file may be used as image file ID 802, or other naming scheme may be used.

Process for Transferring a Virtual Machine

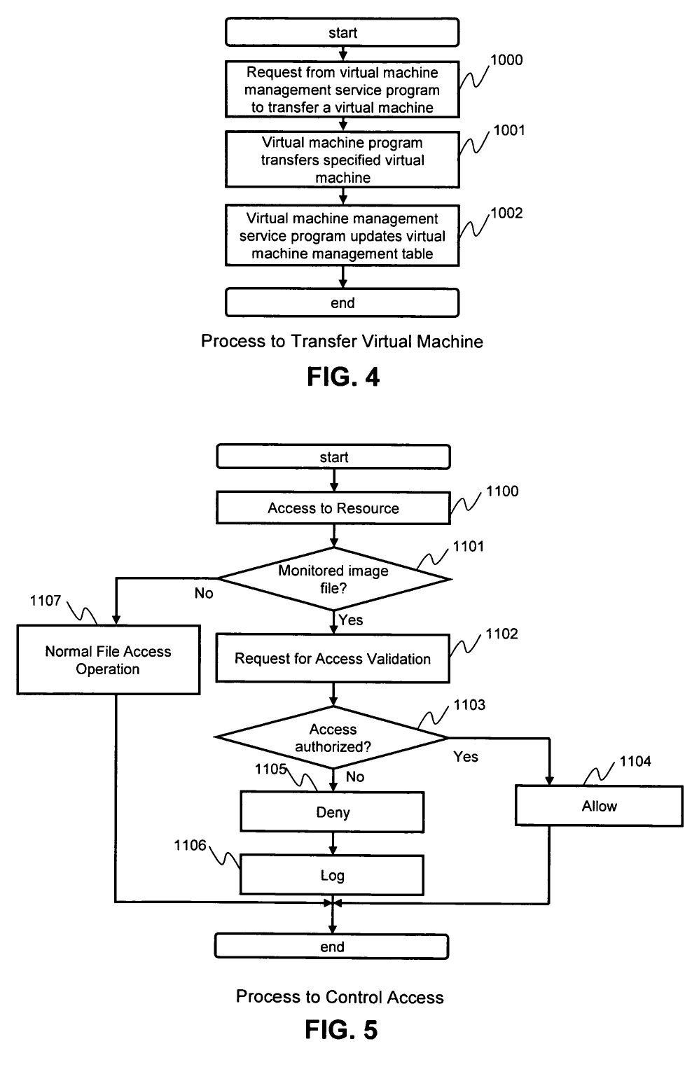

FIG. 4 illustrates an example of a process carried out by virtual machine monitor program 110 and virtual machine management service program 510 to transfer one of virtual machines 111. In this example, a virtual machine 111 is transferred from host computer 1 to host computer 2.

Step 1000: Virtual machine management service program 510 sends a request of transferring a virtual machine 111 to virtual machine monitor program 110 on host computer 1 and host computer 2. The request may identify the particular virtual machine 111 to be moved according to the corresponding virtual machine ID 702 retrieved from virtual machine management table 511.

Step 1001: Virtual machine monitor program 110 on host computer 1 communicates with virtual machine monitor program 110 on host computer 2, and transfers the particular virtual machine 111 that is the subject of the migration request sent by the virtual machine management service program 510. Virtual machine monitor program 110 sends a reply to virtual machine management server program 510 to report the results of the move process.

Step 1002: According to the results of transferring the specified virtual machine 111, virtual machine management search program 510 updates the virtual machine management table 511, and the process ends.

Process for Access Control

FIG. 5 illustrates an example of a process for controlling access from the host computers to network attached storage 3, as executed by network file system service program 310, virtual machine access control program 312, and virtual machine management service program 510. Typically, this request to access the image file takes place during boot up and running of the virtual machine because the image file contains the operating system data that is necessary for virtual machine to run, and thus it is important for the storage system to determine whether access is authorized. But, as described above, existing conventional access control mechanisms can only validate access from virtual machine monitor programs or host computers, and cannot provide end-to-end security from virtual machine to image files.

Step 1100: Network filesystem service program 310 receives an access request from one of host computers 1, 2 directed to a file. Network filesystem service program 310 can identify the host computer from the IP address of the host computer, and is able to validate access using an existing access control mechanism, such as IP address filtering, if necessary. Network filesystem service program 310 also can identify the network filesystem client capability of virtual machine monitor program 110 from authentication information provided by virtual machine monitor program through network filesystem protocol and validate access using existing network filesystem protocol, if necessary.

Step 1101: Network filesystem service program 310 refers to access control configuration table 313 and determines whether the file that the host computer is requesting to access is listed on the access control configuration table 313 as a monitored image file entry 802. If the file that the host computer is trying to access is one of the monitored image file entries 802, then the file is a monitored image file 340, and the process goes to step 1102; otherwise the process goes to step 1107.

Step 1102: Network filesystem service program 310 invokes virtual machine access control program 312. Virtual machine access control program 312 sends an inquiry to virtual machine management service program 510 for validating the access request.

Step 1103: Virtual machine management service program 510 refers to virtual machine management table 511 and determines whether a virtual machine 111 using the particular image file 340 that was the target of the access request is running on the particular host computer that tried to access to the specified image file 340. Virtual machine management service program 510 sends a result of determining whether the access is authorized back to virtual machine access control program 312. Virtual machine management service program 510 may also log the result. If the access request is valid, the process goes to step 1104; otherwise the process goes to the step 1105.

Step 1104: Virtual machine access control program 312 permits the access by the particular host computer to the specified image file 340.

Step 1105: On the other hand, when the result in step 1103 shows that the access request is not authorized, the virtual machine access control program 312 denies the requesting host computer access to the specified image file 340.

Step 1106: Virtual machine access control program 312 can also log the event, and is able to send the log to a log server on the network (not shown in these embodiments).

Step 1107: Network filesystem service program 310 performs normal file access operations when the access request is targeted to a file that is not a monitored image file.

### SECOND EMBODIMENTS

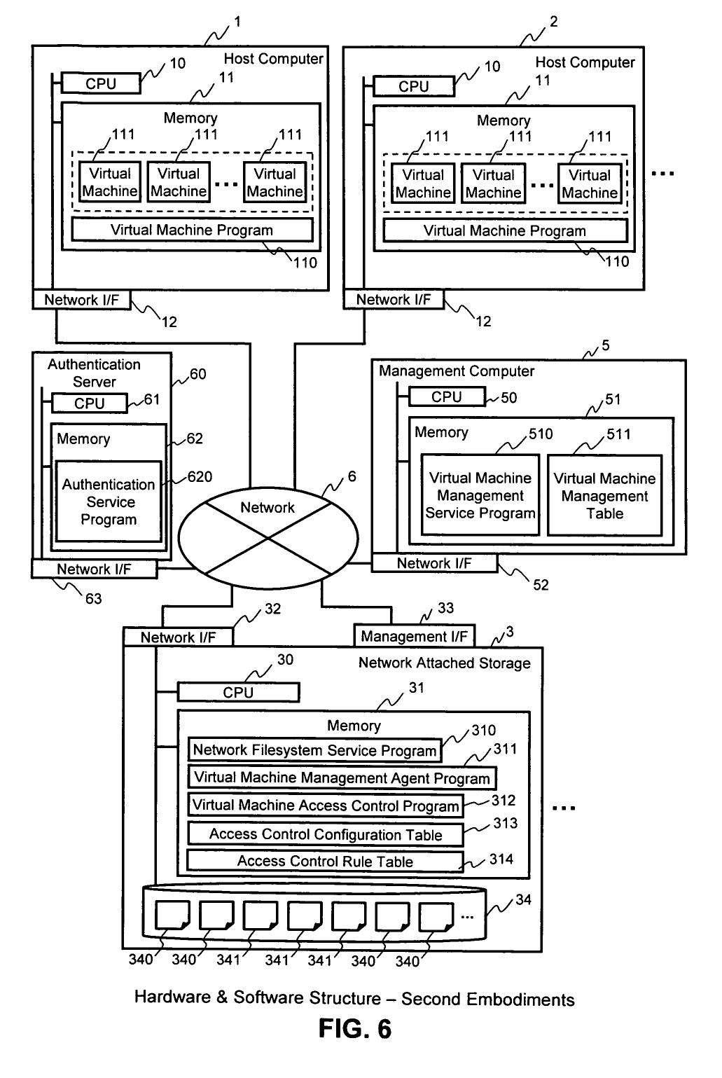

In the first embodiments, network attached storage 3 requests access validation from virtual machine management service program 510. In exemplary second embodiments of the invention, network attached storage 3 validates access autonomously without access to management computer 5. FIG. 6 illustrates an example of a physical hardware and logical software architecture in which the second embodiments of the invention may be applied. In these embodiments, network attached storage 3 may include not only the programs and information described in first embodiments, but also an access control rule table 314. Access control rule table 314 defines access control rule information that is set by virtual machine management service program 510. The access control rule information is used by virtual machine access control program 312 for determining whether to authorize access to a particular image file 340. Thus, access control rule table 314 contains information indicating which host computer is permitted to access which image file 340.

In the second embodiments, virtual machine management agent program 311 provides not only an interface which allows an administrator to set access control configuration information to access control configuration table 313, as described in the first embodiments, but also provides an interface that allows virtual machine management service program to set access control rule information to access control rule table 314 within network attached storage 3. Additionally, virtual machine access control program 312 provides access control capability. Virtual machine access control program 312 is invoked when network filesystem service program 310 receives an access request from a host computer to a monitored image file 340. Virtual machine access control program 312 refers to access control rule table 314, and determines whether the access request should be permitted or denied.

Also, in the second embodiments, in management computer 5, virtual machine management service program 510 provides an interface that allows an administrator to manage and operate virtual machines 111, virtual machine monitor programs 110, and virtual machine access control capability of the network attached storage 3. For example, an administrator is able to move a virtual machine 111 from one host computer to another host computer via virtual machine management service program 510. Virtual machine management service program 510 can also automatically and autonomously move a virtual machine 111 to achieve load balancing of the processing loads on the host computers, or for increasing the availability of a particular application, such as improving response time, and so forth. When a virtual machine is moved, virtual machine management service program 510 updates virtual machine management table 511 so that the virtual machine management table 511 indicates the correct location information of each virtual machine 111. Virtual machine management service program 510 also updates the access control rule table 314 within network attached storage 3 via instructions delivered to virtual machine management agent program 311, so that the access control rule table 314 is consistent with the virtual machine management table 511. An administrator is also able to set access control information directly to access control rule table 314 within the network attached storage 3 via virtual machine management service program 510 and virtual machine management agent program 311.

Virtual machine management table 511 defines the location information of the virtual machines 111, as in the first embodiments. When a virtual machine 111 is moved from one host computer to another host computer, the virtual machine management table 511 is updated by virtual machine management service program 510. An administrator and/or virtual machine management service program 510 is able to recognize the location of each virtual machine 111 by referring to this table 511.

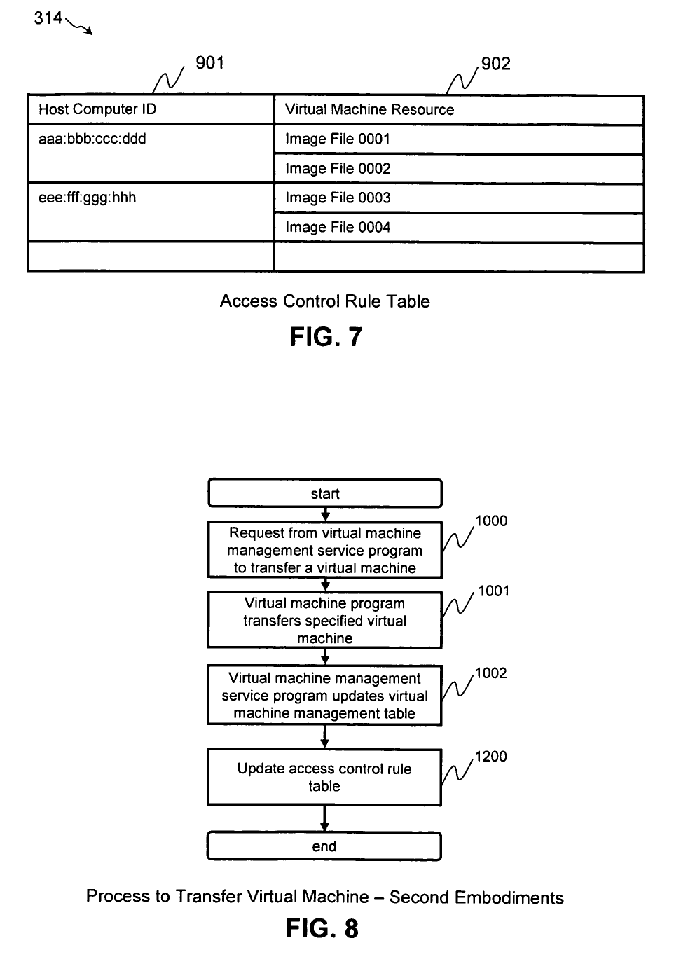

FIG. 7 illustrates an exemplary data structure of the access control rule table 314. In access control rule table 314, a host computer ID entry 901 contains unique identification information of each host computer. In these embodiments, the IP address of each host computer is used as the host computer ID 901. Also, a virtual machine resource entry 902 indicates identification information of each image file 340 of each corresponding virtual machine 111.

Process to Transfer Virtual Machine—Second Embodiments

FIG. 8 illustrates an exemplary process for transferring a virtual machine 111 from one host computer to another host computer by virtual machine monitor program 110, virtual machine management service program 510, and virtual machine management agent program 311. In this example, virtual machine 111 is transferred from host computer 1 to host computer 2.

Steps 1000 through 1002 are the same as described above with respect to FIG. 4, and accordingly, do not need to be described again here.

Step 1200: Virtual machine management service program 510 communicates with virtual machine management agent program 311, and sends host computer ID information of the new location of the transferred virtual machine and virtual machine resource information to the virtual machine management agent program 311. Virtual machine agent program 311 updates the access control rule table 314 so that content of the table is consistent with virtual machine management table 511, and the process ends.

Process for Controlling Access—Second Embodiments

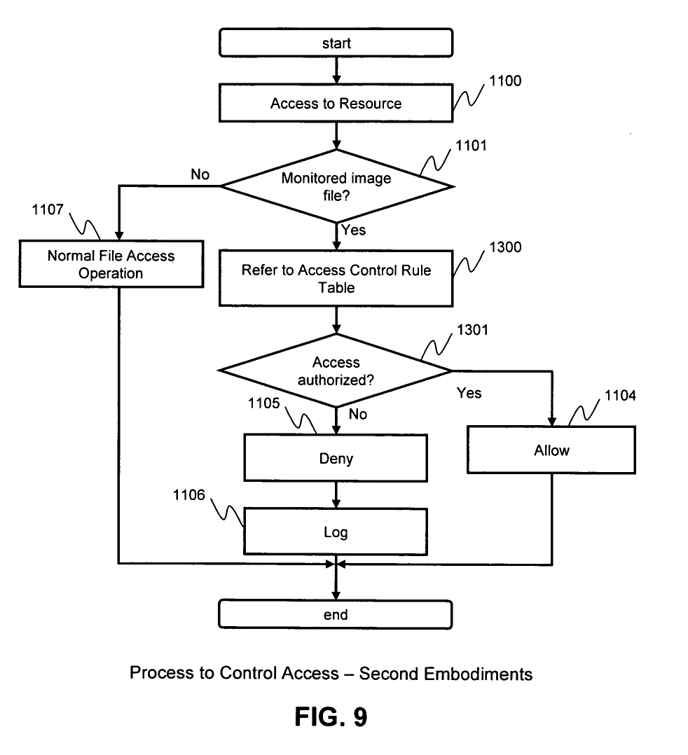

FIG. 9 illustrates an exemplary process for controlling access from a host computer to the network attached storage 3 executed by network filesystem service program 310 and virtual machine access control program 312.

Steps 1100 through 1101 are the same as described above with respect to FIG. 5, and accordingly, do not need to be described again here.

Step 1300: Network filesystem service program 310 invokes virtual machine access control program 312 by sending an inquiry to virtual machine access control program 312 for validating the access request.

Step 1301: Virtual machine access control program 312 checks the access control rule table 314 and determines whether the host computer is supposed to be permitted to access to the particular image file specified in the access request. If the access request is authorized according to the determination made from referring to the access control table 314, the process goes to step 1104; otherwise the process goes to step 1105.

Steps 1104 through 1107 are the same as described above with respect to FIG. 5, and accordingly, do not need to be described again here.

### THIRD EMBODIMENTS

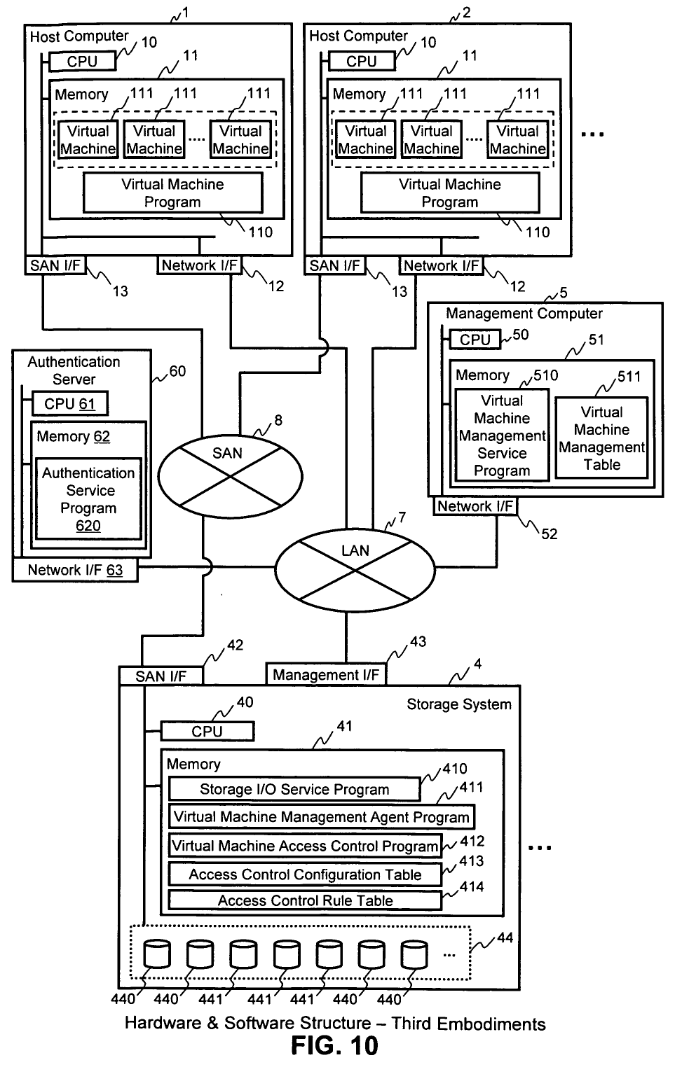

Embodiments of the invention can be used not only for network attached storage (i.e., file-based storage protocols), as described in the first and second embodiments, but also can be applied in information systems that use block-based storage protocols (e.g., SCSI, iSCSI, etc.) and that incorporate a SAN (Storage Area Network) connected to a storage system in some embodiments. FIG. 10 illustrates an example of a physical hardware and logical software architecture in which exemplary third embodiments of the invention may be carried out. The overall information system in the exemplary embodiments consists of at least two host computers 1, 2, at least one storage system 4, and a management computer 5. These components are connected to each other for communication through a LAN (Local Area Network) 7. In addition, host computers 1, 2 and storage system 4 are connected for communication via a SAN (Storage Area Network) 8. For example, in some embodiments, SAN 8 may be a Fibre Channel (FC) or other type of communication network which enables high-speed or dedicated transmission of storage data between host computers 1, 2 and storage system 4. Host computers 1, 2 comprise at least one CPU 10, at least one memory 11, at least one LAN interface 12 that is used for connecting to LAN 7, and at least one SAN interface 13 that is used for connecting to SAN 8.

In the illustrated third embodiments, virtual machine monitor programs 110 on host computers 1, 2 store image files of virtual machines 111 into logical volumes 44 within storage system 4 using SAN interface. In this case, virtual machines do not have their own network identifier in SAN in this embodiment. Thus, the storage system 4 cannot recognize virtual machines in the same manner as network attached storage 3 in first and second embodiments described above. When multiple virtual machines 111 are running on the host computers 1, 2, storage system 4 cannot recognize which virtual machines are running on which host computers. Storage system 4 is able to authenticate the SAN interface of the host computers 1, 2 and apply access control for logical volumes 44, but storage system 4 cannot validate access from virtual machines to logical volumes.

Storage system 4 includes at least one CPU 40, at least one memory 41, and at least one SAN interface 42 that is used for connecting to SAN 8. Storage system 4 also has at least one management interface 43 that is connected to LAN 7 and that allows an administrator to manage and operate storage system 4, such as from management computer 5. Storage system 4 also contains one or more logical volumes 44 in these embodiments. Logical volumes are created from a plurality of physical storage mediums, such as hard disk drives, flash memory, optical disc, tape, or the like. Some logical volumes 440 can contain image files of the virtual machines 111 that are running on host computers 1, 2, while logical volumes 441 may contain other data, such as that used by applications that run on the virtual machines 111.

Storage system 4 also includes a number of software programs similar to those discussed above in the earlier embodiments. These programs and information used by the programs are stored in memory 41 or other computer readable medium, and are executed by CPU 40. A storage I/O service program 410 provides an interface that allows host computers to store data in SAN 8. The interface can be a typical network block storage command interface such as Fibre Channel SCSI or iSCSI. When storage I/O service program 410 receives an access request from a host computer to one of the monitored logical volumes 440, storage I/O service program 410 invokes virtual machine access control program 312.

A virtual machine management agent program 411 provides an interface that allows an administrator to set access control configuration information to an access control configuration table 413 within storage system 4 via virtual machine management service program 510. Using access control configuration information, an administrator defines logical volumes 440 that should be monitored by storage system 4, to enable later determination as to whether or not particular logical volumes 440 should be permitted to be accessed by particular host computers.

Virtual machine access control program 412 provides access control capability for allowing or denying access to the monitored volumes 440. Virtual machine access control program 412 is invoked when storage I/O service program 410 receives an access request from a host computer to one of monitored logical volumes 440. Virtual machine access control program 412 sends an inquiry to virtual machine management service program 510 to validate the access request. Virtual machine access control program 412 allows or denies the access request according to a reply received from virtual machine management service program 510 in response to the inquiry. Virtual machine access control program 412 can also log the event.

Access control configuration table 413 defines access control configuration information that is set by an administrator via virtual machine management service program 510. Access control configuration table 413 is used by storage I/O service program 410 and virtual machine access control program 412. Storage I/O service program 410 refers to access control configuration table 413 to determine whether an access request from a host computer to a certain logical volume should be validated or not, by determining whether the particular logical volume specified in the access request is a monitored logical volume 440. Access control configuration table 413 has a structure similar to access control configuration table 313, as illustrated in FIG. 3, except that monitored image file 802 is instead “monitored logical volume”, and indicates unique identification information of each monitored logical volume 440 of the virtual machines 111 that should be monitored by storage system 4.

Additionally, virtual machine management table 511 in these embodiments may have the same structure as illustrated in FIG. 2. For example, storage ID 703, which indicates unique identification information of each storage system 4, in these embodiments, may include the IP address of the management interface 43 of storage system 4 as the storage ID. Furthermore, virtual machine resource 704 indicates identification information of the monitored logical volumes 440 that contain image files of the virtual machines. Similarly, access control rule table 414 may have the same structure as illustrated in FIG. 7 for access control rule table 314. For example, virtual machine resource entry 902 may indicate identification information of each monitored logical volume 440 of each virtual machine. Thus, in alternative third embodiments, the storage system may autonomously determine whether to allow access by referring to access control rule table 414, without sending an inquiry to management computer 5, or waiting to receive a reply.

Process Flow

In the third embodiments, the process for transferring a virtual machine may be the same as illustrated in FIGS. 4 and 8, with logical volumes 440 being used instead of image files 340. Namely, the process of FIG. 4 is used if the management computer 5 is managing access control, and the process of FIG. 8 is used if the storage system is managing access control and includes access control rule table 414. Similarly, the process to control access may be the same as illustrated in FIGS. 5 and 9. Namely, the process of FIG. 5 is used if the management computer 5 is managing access control, and the process of FIG. 9 is used if the storage system is managing access control and includes access control rule table 414.

Consequently, it should be evident that when virtual machines access a storage system, embodiments of the invention enable the storage system to recognize whether individual virtual machines are running on host computers and virtual machine monitor programs, and determine whether the host computers and virtual machine monitor programs should be allowed to access particular image files corresponding to particular virtual machines. Thus, in embodiments of the invention, the storage system is able to keep track of the location and movement of each virtual machine, and therefore is able to appropriately restrict unauthorized access from host computers and virtual machine monitor programs to files or volumes containing virtual machine system resources within the storage system. According to embodiments of the invention, the storage system can also receive access control rule information from the virtual machine management computer to validate an access request autonomously.

Of course, the systems illustrated in FIGS. 1, 6 and 10 are purely exemplary of information systems in which the present invention may be implemented. The management computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, for purposes of explanation, numerous details are set forth in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods and apparatuses for managing and controlling access from virtual machines to files or volumes within the storage system. Additionally, while specific embodiments have been illustrated and described in this specification, those of ordinary skill in the art appreciate that any arrangement that is calculated to achieve the same purpose may be substituted for the specific embodiments disclosed. For example, although specific hardware architectures were used to illustrate the present invention, it can be appreciated that other hardware architectures may be used instead. The description and abstract are not intended to be exhaustive or to limit the present invention to the precise forms disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. An information system comprising:
a first computer having a first program running thereon for generating virtual machines able to run on said first computer;
a second computer having a second program running thereon for generating virtual machines able to run on said second computer;
a storage system in communication with said first computer and said second computer, said storage system storing an image file corresponding to each virtual machine running on said first computer or said second computer,
wherein, when said storage system receives an access request to a particular image file corresponding to a particular one of said virtual machines running on one of said first or second computers, said storage system is configured to determine whether the access request is authorized based upon an identifier of said particular virtual machine and a location of said particular virtual machine.

2. The information system according to claim 1, further comprising:
a third computer in communication with the storage system, said first computer and said second computer;
said third computer configured to store virtual machine identification information and location information.

3. The information system according to claim 2,
wherein said storage system is configured to send an inquiry to said third computer when determining whether the access request is authorized, and
wherein, based upon the location of the particular virtual machine and the identifier of the particular virtual machine, said third computer is configured to send a reply as to whether the access request is authorized.

4. The information system according to claim 2,
wherein said third computer is configured to register a location of each said virtual machine and an identifier of each said virtual machine at the third computer.

5. The information system according to claim 2,
wherein, when one of said virtual machines is transferred from the first computer to the second computer, a said third computer is configured to register a new location for the transferred virtual machine at said third computer.

6. The information system according to claim 5,
wherein said storage system is configured to also register said new location for the transferred virtual machine at said storage system.

7. The information system according to claim 1,
wherein said storage system is a network attached storage system receiving access requests in a file-based protocol.

8. The information system according to claim 1,
wherein said storage system is configured to refer to virtual machine location information stored in said storage system when determining whether said access request is authorized to access said particular image file.

9. The information system according to claim 2,
wherein said storage system is configured to refer to virtual machine location information stored in said storage system when determining whether said access request is authorized to access said particular image file.

10. The information system according to claim 1,
wherein said storage system receives access requests in block-based protocol,
wherein said image files are stored in logical volumes in said storage system, and
wherein said determination of whether the access request is authorized includes determining whether the particular virtual machine is in a location that is authorized to access a particular volume storing said particular image file.

11. A method of operating an information system having a first computer, a second computer, and a storage system in communication with said first computer and said second computer, the method comprising:
running a first program on the first computer for generating virtual machines able to run on said first computer;
running a second program on the second computer for generating virtual machines able to run on said second computer;
storing, at said storage system, an image file corresponding to each virtual machine running on said first computer or said second computer;
receiving, at said storage system, an access request to a particular image file corresponding to a particular one of said virtual machines running on one of said first or second computers; and
allowing access to said particular image file in response to said access request when said storage system determines that the access request is authorized based upon an identifier of said particular virtual machine and a location of said particular virtual machine.

12. The method of operating an information system according to claim 11, further including a step of:
providing a third computer in communication with the storage system, the first computer and the second computer, said third computer storing virtual machine identification information and location information.

13. The method of operating an information system according to claim 12, further including steps of:
sending an inquiry by said storage system to said third computer when determining whether the access request is authorized; and
based upon a location of the particular virtual machine and the identifier of the particular virtual machine, sending, by said third computer, a reply as to whether the access request is authorized.

14. The method of operating an information system according to claim 12, further including a step of:
registering the location of each said virtual machine and an identifier of each said virtual machine at the third computer.

15. The method of operating an information system according to claim 12, further including a step of:
wherein, when one of said virtual machines is transferred from the first computer to the second computer, a new location for the transferred virtual machine is registered at said third computer.

16. The method of operating an information system according to claim 15, further including a step of:
registering said new location for the transferred virtual machine at said storage system also.

17. The method of operating an information system according to claim 11, further including a step of:
referring, by said storage system, to virtual machine location information stored in said storage system when determining whether a source of said access request is authorized to access said particular image file.

18. The method of operating an information system according to claim 11, further including steps of:
storing said image files in logical volumes in said storage system,
wherein said determination of whether the access request is authorized includes determining whether a particular virtual machine corresponding to the particular image file stored in a particular volume is in a location that is a source of the access request.

19. An information system comprising:
a first computer having a first virtual machine program running thereon for generating virtual machines able to run on said first computer;
a second computer having a second virtual machine program running thereon for generating virtual machines able to run on said second computer;
a storage system in communication with said first computer and said second computer, said storage system storing an image file corresponding to each virtual machine running on said first computer or said second computer;
a third computer in communication with the storage system, the first computer and the second computer, said third computer storing virtual machine identification information and location information for each said virtual machine,
wherein, when one of said virtual machines is transferred from the first computer to the second computer, said third computer is configured to register a new location for the transferred virtual machine at said third computer,
wherein, when said storage system receives an access request to an image file corresponding to the transferred virtual machine, said storage system is configured to determine whether the access request is authorized, and send an inquiry to said third computer for determining whether the access request is authorized, and
wherein said third computer is configured to send a reply to the storage system as to whether the access request is authorized based upon the new location of the transferred virtual machine, the identifier of the transferred virtual machine, and the corresponding image file.

20. The information system according to claim 19,
wherein each said image file is stored in a logical volume in said storage system, and
wherein said determination of whether the access request is authorized includes determining whether a source of the access request is the new location of the transferred virtual machine that corresponds to said corresponding image file stored in a particular logical volume.
